(19) United States
(12) Patent Application Publication
(10) Pub. No.: US 2010/0281275 A1
(43) Pub. Date: Nov. 4, 2010

(54) METHOD OF RECORDING CONTENT ON DISC, METHOD OF PROVIDING TITLE KEY, APPARATUS FOR RECORDING CONTENT ON DISC, AND CONTENT PROVIDING SERVER

(75) Inventors: Dae-Jong Lee, Suwon-si (KR); Kil-Soo Jung, Osan-si (KR); Sung-Ryeul Rhyu, Yongin-si (KR); Man-Seok Kang, Suwon-si (KR); Joon-Hwan Kwon, Suwon-si (KR)

Correspondence Address: North Star Intellectual Property Law, PC, P.O. Box 34688, Washington, DC, 20043, US

(73) Assignee: SAMSUNG ELECTRONICS CO., LTD., Gyeonggi-do (KR)

(21) Appl. No.: 12/811,905

(22) PCT Filed: Aug. 28, 2008
(86) PCT No.: PCT/KR08/05038

§ 371 Date: Jul. 7, 2010

(30) Foreign Application Priority Data
Jan. 9, 2008 (KR) 10-2008-0002651

(51) Int. Cl. G06F 12/14; H04L 9/08

(52) U.S. Cl. 713/193; 380/279; 380/285

(57) ABSTRACT

Provided are a method of recording content, a method of providing a title key, an apparatus for recording content, and a content providing server, which can prevent unauthorized users from recording the title key on a plurality of discs. The method of recording content downloaded from a network includes: receiving a title key, which is encrypted with a disc key of a disc on which content is to be recorded in a recording apparatus, from a server; and recording the received title key and the content on the disc.

### CROSS-REFERENCE TO RELATED APPLICATIONS

This application is a National Stage entry of International Application No. PCT/KR2008/005038, filed on Aug. 28, 2008, which claims the benefit of Korean Patent Application No. 10-2008-0002651, filed on Jan. 9, 2008, in the Korean Intellectual Property Office, the entire disclosure of each of which is incorporated herein by reference for all purposes.

### BACKGROUND

1. Field

The following description relates to a method of recording content, a method of providing a title key, an apparatus for recording content, and a content providing server, which can prevent unauthorized users from recording the title key on a plurality of discs.

2. Description of Related Art

The recent rapid development of network infrastructure enables moving pictures to be easily traded through the Internet. Some service providers plan to provide services that allow a user or a rental shop to download video content through the Internet to a digital versatile disc (DVD). Consumers will be able to enjoy high quality video content at home while saving money and time if a charge for this service is lower than a DVD purchase price. Storing the video on a DVD will save the users time and money in that the content may only need to be downloaded once, and the DVD may be reused without wasting space on the user's computer.

That is, content providers may use a network in order to more easily sell content, and users may be able to easily download various movie content through the network. As such, since there is a high possibility that the content downloaded through the network will be illegally copied and modified, there is an increasing need for protection against such illegal copying or modification. One type of illegal copying is interception of a data stream by an unauthorized user.

Content scrambling system (CSS) is a digital rights management (DRM) scheme used to prevent people from illegally copying and modifying content. Accordingly, a content provider may try to prevent content from being illegally copied and modified while transmitting the content to an authorized user by using DRM. In order to use DRM, the right to use keys for reproducing encrypted content recorded on a recording medium needs to be acquired, and a method of securely transmitting content between a user and the content provider is needed.

In particular, since a DVD can be directly played on a personal computer (PC) unlike in the case of other media, the possibility that the DVD may be copied to other hard discs is very high. CSS, which is a DRM scheme, has been suggested to prevent such illegal copying.

CSS reproduces video data by using a plurality of keys and decryption processes. The keys used by the CSS include: an encrypted disc key used to decrypt encrypted title keys, stored in a disc, and uniquely assigned to each disc; an encrypted title key uniquely assigned to each video title set (VTS), used to decrypt encrypted some or all video data included in the VTS, and stored in a header of each title; and a player key uniquely assigned to each of DVD reproducing apparatus for consumers and reproduction software for PCs, and used to decrypt disc key.

FIG. 1 is a view for explaining a method of reproducing a CSS-encrypted DVD 100.

Referring to FIG. 1, the DVD 100 includes an encrypted disc key, encrypted title keys, and scrambled video data. The keys are typically stored in a lead-in area of the DVD 100. In operation 130, a reproducing apparatus 110 decrypts the encrypted disc key by using a player key stored therein to obtain a disc key 140. In operation 150, the reproducing apparatus 110 decrypts the encrypted title keys by using the disc key 140 to obtain a title key 160. In operation 170, the reproducing apparatus 110 de-scrambles the scrambled video data by using the title key 160 to obtain and reproduce video data.

CSS managed recording is a technology that enables commercial content to be downloaded through a network and recorded on an empty DVD by using the same CSS as a prerecorded commercial DVD title.

FIG. 2 is a view for explaining CSS managed recording.

Referring to FIG. 2, a content providing server 210 provides a title key 230 and video data 220, which is CSS encrypted with the title key 230, to a user 240. A user recording apparatus 250 of the user 240 records the encrypted video data 220 on a disc 270 by using the title key 230 and also records a title key 280, which is encrypted with a disc key 290, on the disc 270. The disc key 290, which is encrypted with a player key 260, is already stored in the disc 270.

FIGS. 3A and 3B are views for explaining encryption and decryption expressions. FIG. 3A shows an example in which a message is encrypted by using an A key, which may be expressed as E[A key, message]. FIG. 3B shows an example in which a message, which is encrypted with an A key, is decrypted by using the A key, which may be expressed as D[A key, E[A key, message]].

FIGS. 4A to 4G are views for explaining the application of conventional CSS managed recording.

Referring to FIG. 4A, a content providing server 210 includes a title key 230 and content 220 that is encrypted with the title key 230. A player key 260 is stored in a user recording apparatus 250 of a user, usually by the manufacturer of the recording apparatus 250, and a user public key CEpub Key 410 and a user private key CEpriv Key 420 form a public key set for the user to securely transmit and decrypt the title key 230. The user public key CEpub Key 410 and the user private key CEpriv Key 420 are a key set generated by public-key cryptography, and the same key set is assigned by the manufacturer to all devices, that is, recording apparatuses, of the same model. Public-key cryptography is a form of cryptography in which a pair of keys, i.e., a public key and a private key are used. Any one of the pair of keys can be used to encrypt data and the other key can be used to decrypt the encrypted data. In general, while the public key is widely distributed to all users, the private key is kept secret by a key owner. Thus the terms “public” and “private.”

Referring to FIG. 4B, in order to securely obtain the title key 230 required to reproduce the encrypted content 220 from the content providing server 210, the user transmits the user public key 410, which is to be used to encrypt the title key 230, to the content providing server 210.

Referring to FIG. 4C, the content providing server 210 encrypts the title key 230 by using the user public key 410 received from the user, and transmits a title key 430, encrypted with the user public key 410, to the user recording apparatus 250 along with the content 220 that is encrypted with the title key 230.

Referring to FIG. 4D, the user recording apparatus 250 decrypts the title key 430 by using the user private key 420 to extract the title key 230. The title key 430 is encrypted with the user public key 410.

Referring to FIG. 4E, the user recording apparatus 250 extracts a disc key 290, which is encrypted with the player key 260, from the recording disc 270, and decrypts the disc key 290, encrypted with the player key 260, by using the player key 260 stored in the user recording apparatus 250 to obtain a disc key 440.

Referring to FIG. 4F, the user recording apparatus 250 encrypts the title key 230 received from the content providing server 210 by using the disc key 440 to generate a title key 450 that is encrypted with the disc key 440.

Referring to FIG. 4G, the user recording apparatus 250 records the CSS encrypted content 220, which is downloaded from the content providing server 210, and the title key 450, which is encrypted with the disc key 440, on the recording disc 270.

FIGS. 5A to 5E are views for explaining problems caused during the application of the conventional CSS managed recording of FIGS. 4A to 4G.

Referring to FIG. 5A, recording apparatuses 250 of the same model have the same public key 410 and the same private key 420. Both an authorized user A and an unauthorized user B can download CSS encrypted content from a content providing server 210.

Referring to FIG. 5B, the authorized user A trying to buy a title key 430 for the purpose of recording the downloaded content on a recording disc transmits a user public key 410 of the user recording apparatus 250 for encrypting the title key 430 to the content providing server 210. The content providing server 210 encrypts the title key 430 by using the received public key 410 of the user recording apparatus 250.

Referring to FIG. 5C, while the content providing server 210 transmits the title key 430, encrypted with the public key 410 of the recording apparatus 250, to the user recording apparatus 250 of the authorized user A, the unauthorized user B may intercept the title key 430.

Referring to FIG. 5D, the unauthorized user B intercepting the title key 430, encrypted with the public key 410 of the user recording apparatus 250, has the same key set as that of the authorized user A because the user recording apparatuses 250 of the authorized user A and the unauthorized user B are of the same model. As described above, the same key set is assigned by the manufacturer to all devices of the same model. Accordingly, the unauthorized user B can decrypt the title key 430, which is encrypted with the public key 410, by using a private key 420 of the user recording apparatus 250 and extract a title key 230. Also, the unauthorized user B can encrypt the extracted title key 230 by using a disc key 440 and generate a title key 450, which is encrypted with the disc key 440. As a result, the unauthorized user B can record the content on a recording disc without buying the title key 430.

Referring to FIG. 5E, since the unauthorized user B can extract a disc key 530 from a new disc 510 and encrypt the title key 230 by using the disc key 530, the unauthorized user B can record the content on the new disc 510, as well. That is, as the unauthorized user B is able to store the decrypted title key 230, the unauthorized user B can extract a disc key from a new recording disc and encrypt the title key 230 by using the extracted disc key, and thus the unauthorized user B can record the content on as many discs as they desire.

### SUMMARY

In one general aspect, there is provided a method of recording content downloaded from a network, the method including: receiving a title key from a server, the title key being encrypted with a disc key of a disc on which content is to be recorded in a recording apparatus, and recording the received title key and the content on the disc.

The method may further include that the receiving of the title key from the server includes transmitting the disc key to the server.

The method may further include that the transmitting of the disc key to the server includes: receiving a public key of the server from the server, encrypting the disc key by using the public key of the server, and transmitting the disc key to the server, the disc key being encrypted with the public key of the server.

In another general aspect, there is provided a method of providing a title key to a recording apparatus for recording content downloaded from a network, the method including: receiving a disc key of a disc on which content is to be recorded from the recording apparatus, encrypting the title key by using the received disc key, and transmitting the title key to the recording apparatus, the title key being encrypted with the disc key.

The method may further include that the receiving of the disc key from the recording apparatus includes: transmitting a public key of the server to the recording apparatus, and receiving the disc key from the recording apparatus, the disc key being encrypted with the public key of the server.

The method may further include that the encrypting of the title key by using the received disc key includes: decrypting the disc key by using a private key of the server to obtain the disc key, the disc key being encrypted with the public key of the server, and encrypting the title key by using the disc key, the title key having been used to encrypt the content.

In another general aspect, there is provided an apparatus for recording content downloaded from a network, the apparatus including: a recording unit configured to record downloaded content on a disc, and a control unit configured to: receive the content and a title key from a content providing server, the title key being encrypted with a disc key of a disc on which content is to be recorded, and control the recording unit to record the title key and the content on the disc, the title key being encrypted with the received disc key.

The apparatus may further include that the control unit is further configured to transmit the disc key to the server in order to receive the title key from the server, the title key being encrypted with the disc key.

The apparatus may further include: an encryption/decryption unit encrypting/decrypting data, wherein, in order to transmit the disc key to the server, the control unit is further configured to: control the encryption/decryption unit to encrypt the disc key by using the public key of the server received from the server, and transmit the disc key to the server, the disc key being encrypted with the public key of the server.

In another general aspect, there is provided a content providing server for providing a title key to a recording apparatus for recording content downloaded from a network, the content providing server including: an encryption/decryption unit configured to encrypt and decrypt data, and a control unit configured to: receive a disc key of a disc on which the content is to be recorded from the recording apparatus, control the encryption/decryption unit to encrypt the title key by using the received disc key, and transmit the title key and the content to the recording apparatus, the title key being encrypted with the disc key.

The content providing server may further include that, in order to receive the disc key from the recording apparatus, the control unit is further configured to: transmit a public key of the server to the recording apparatus, and receive the disc key from the recording apparatus, the disc key being encrypted with the public key of the server.

The content providing server may further include that the control unit is further configured to control the encryption/decryption unit to: decrypt the disc key by using a private key of the server to obtain the disc key, the disc key being encrypted with the public key of the server, and encrypt the title key by using the disc key, the title key having been used to encrypt the content.

Other features and aspects will be apparent from the following detailed description, the drawings, and the claims.

### BRIEF DESCRIPTION OF THE DRAWINGS

FIG. 1 is a view for explaining a method of reproducing a content scrambling system (CSS)-encrypted digital versatile disc (DVD).

FIG. 2 is a view for explaining CSS managed recording.

FIG. 3 is a view for explaining encryption and decryption expressions.

FIGS. 4A to 4G are views for explaining the application of conventional CSS managed recording.

FIGS. 5A to 5E are views for explaining problems caused during the application of the conventional CSS managed recording of FIGS. 4A to 4G.

FIGS. 6A to 6F are views is a view for explaining a method of transmitting and receiving data between a content providing server and a user recording apparatus according to an embodiment.

FIG. 7 is a view for explaining advantages of the method of FIGS. 6A to 6F when an unauthorized user intercepts a title key.

FIG. 8 is a block diagram of a content providing server and a user recording apparatus according to an embodiment.

FIG. 9 is a flowchart illustrating a method of recording encrypted content in a user recording apparatus according to an embodiment.

FIG. 10 is a flowchart illustrating a method of providing a title key from a content providing server to a user recording apparatus according to an embodiment.

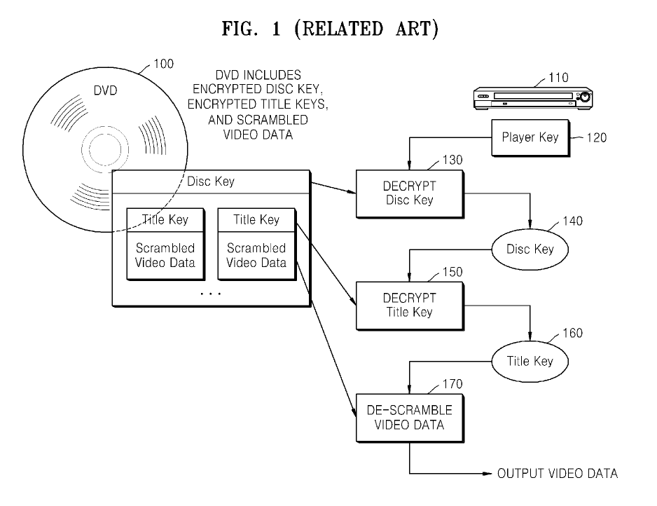

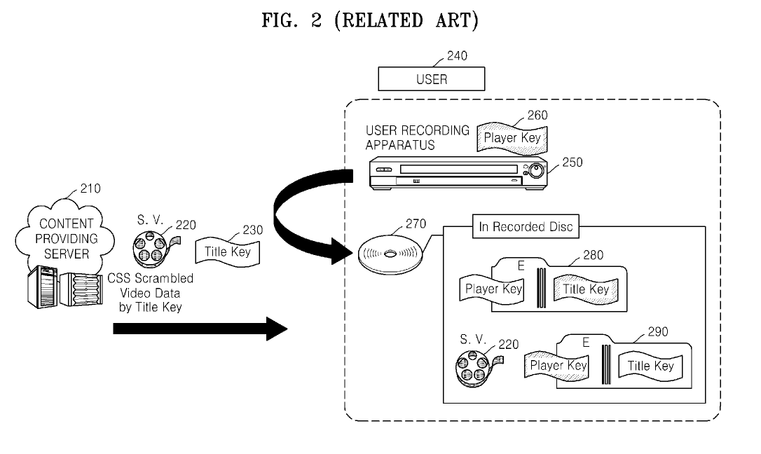

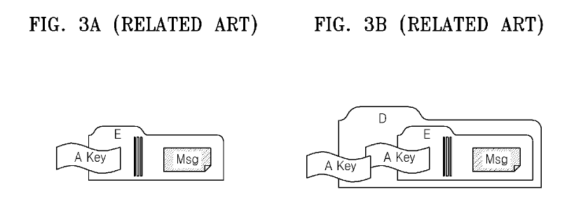

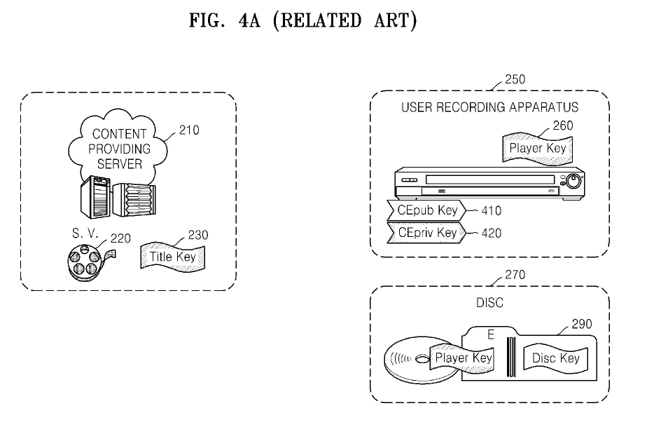

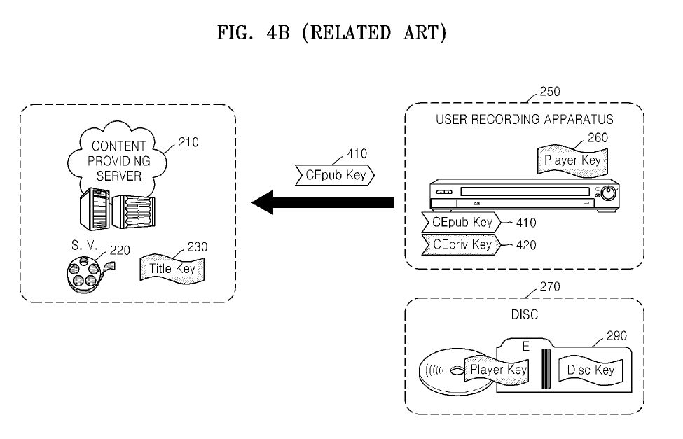

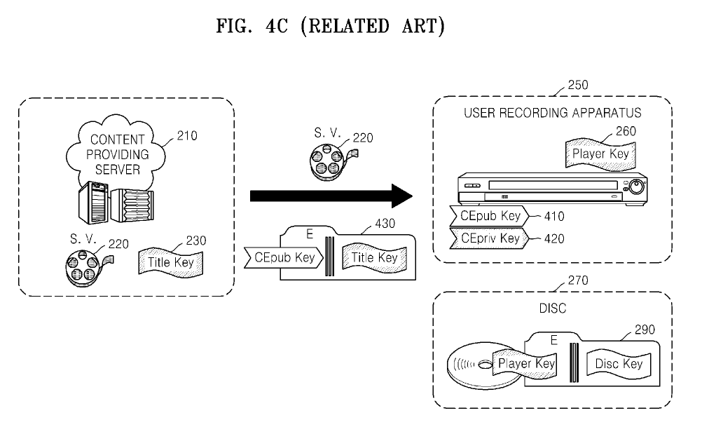

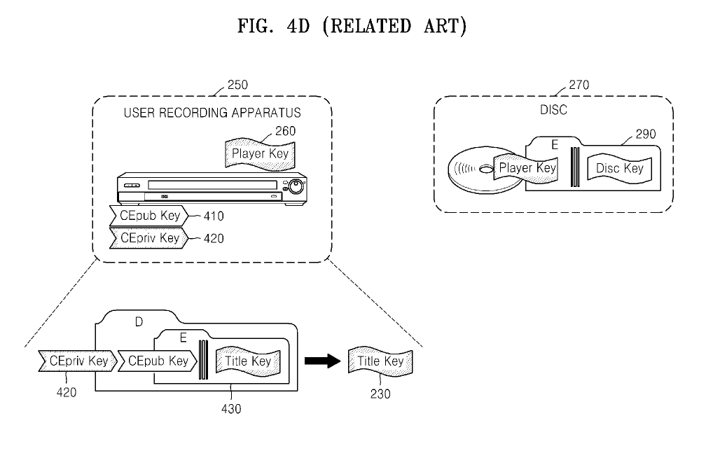

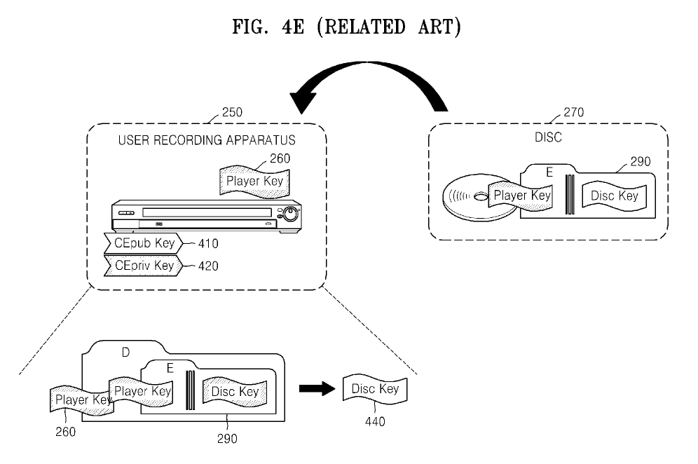

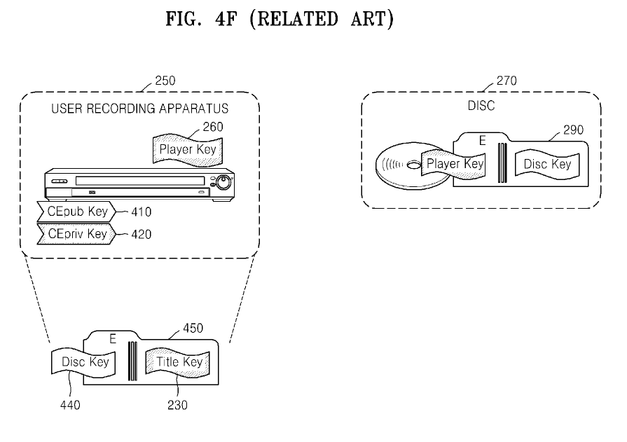

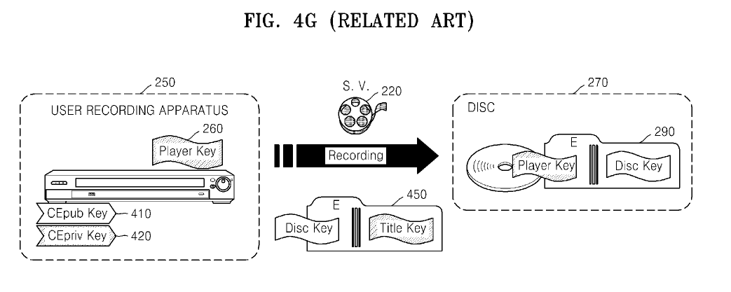

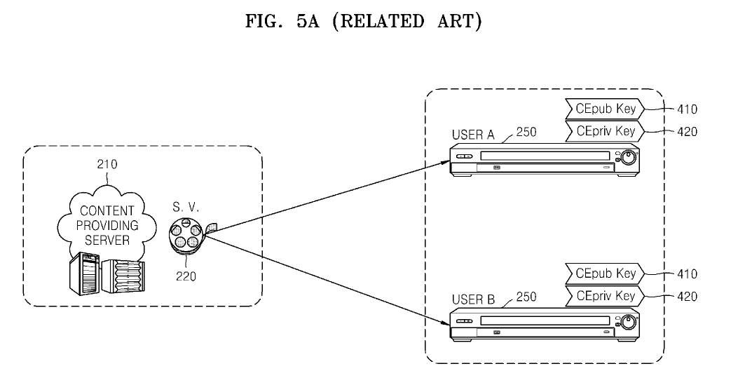

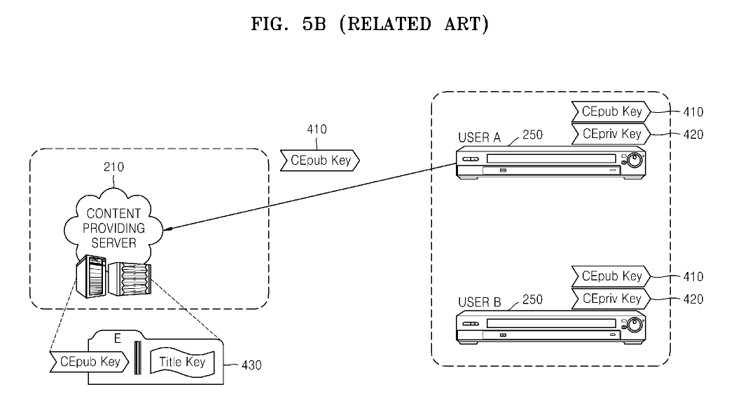

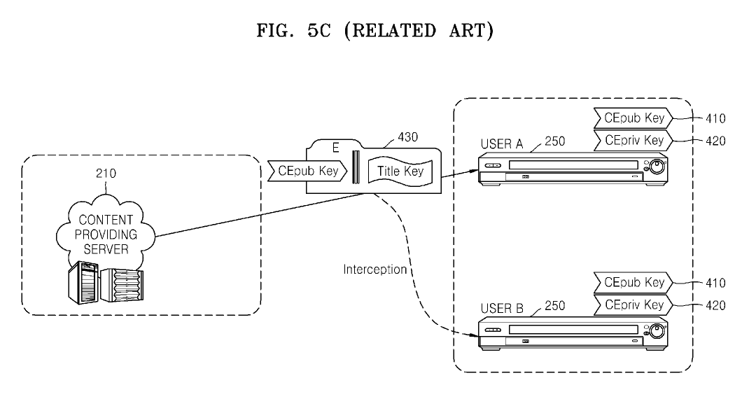

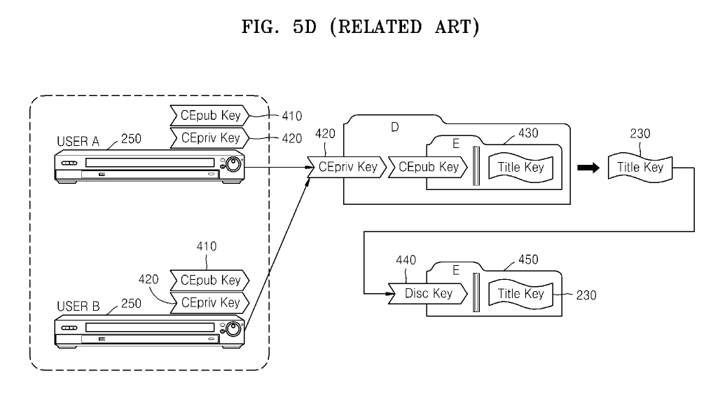

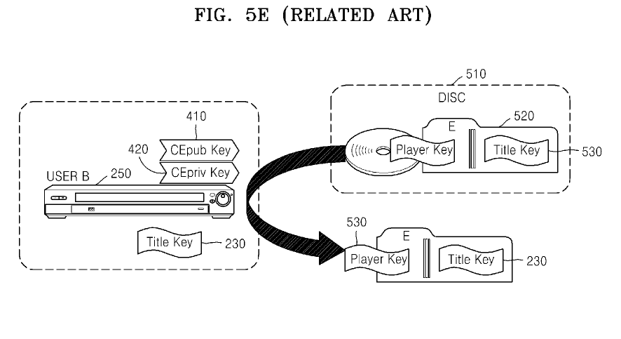

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

Embodiments provide a method of recording content, a method of providing a title key, an apparatus for recording content, and a content providing server, which can prevent unauthorized users from recording the title key on a plurality of discs.

According to embodiments, unauthorized users cannot record a title key on a plurality of discs.

For the purpose of preventing an unauthorized user who intercepts an encrypted title key from decrypting the encrypted title key, embodiments use a public key and a private key generated by a content providing server to receive a title key, which is encrypted with a disc key obtained by an authorized user, from the content providing server, and securely transmit the disc key, which only the authorized user owns, to the content providing server.

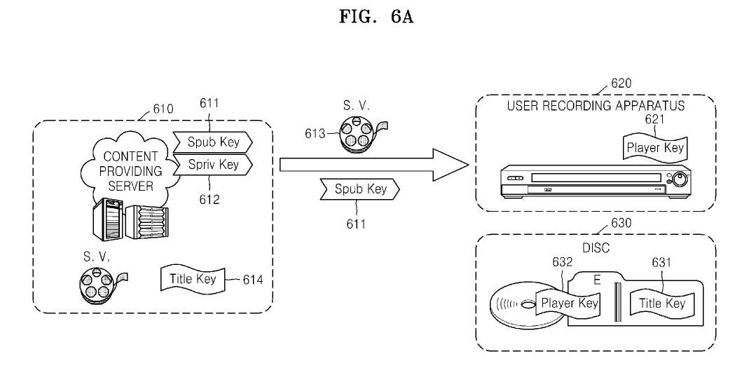

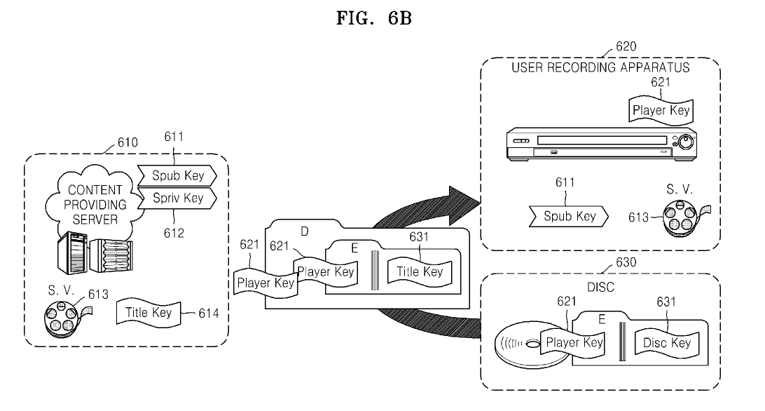

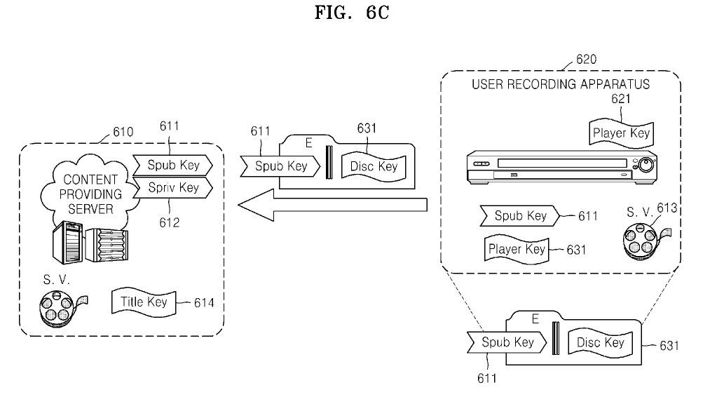

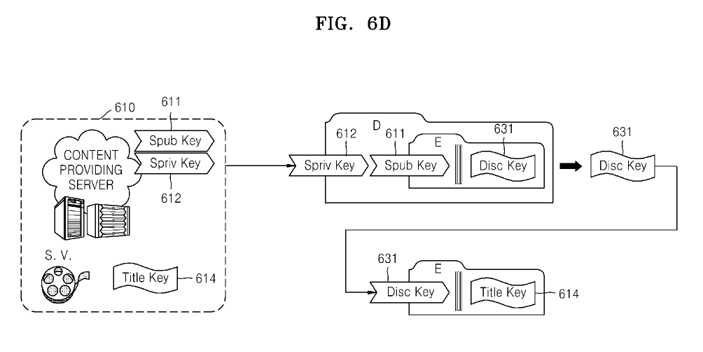

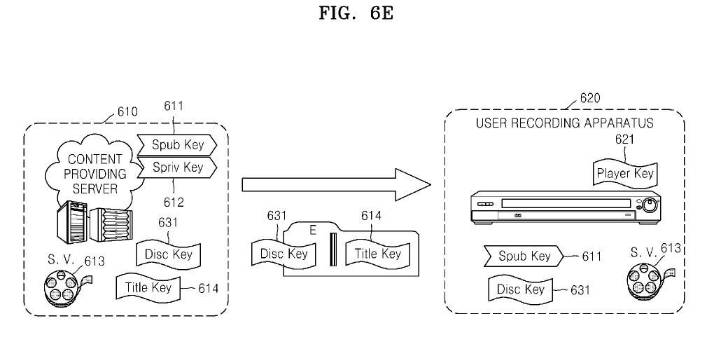

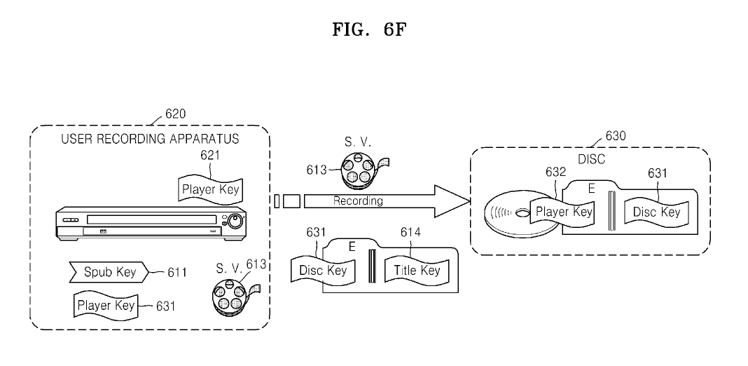

FIGS. 6A to 6F are views for explaining a method of transmitting and receiving data between a content providing server 610 and a user recording apparatus 620 according to an embodiment.

Referring to FIG. 6A, the content providing server 610 may include a public key 611, a private key 612, a title key 614, and content 613 that is encrypted with the title key 614. The user recording apparatus 620 may include a player key 621 stored therein, and a disc 630 on which the content 613 is to be recorded and in which a disc key 631 is stored. The disc key 631 is encrypted with the player key 621.

The user recording apparatus 620 may receive the content 613 and the public key 611 from the content providing server 610. The content 613 is a content scrambling system (CSS) encrypted with the title key 614. The encrypted content 613 and the public key 611 of the content providing server 610 may be transmitted together or may be separately transmitted to the user recording apparatus 620.

Referring to FIG. 6B, the user recording apparatus 620 may extract the disc key 631, which is encrypted with the player key 621, from the disc 630, and may decrypt the disc key 631, which is encrypted with the player key 621, by using the player key 621 to obtain the disc key 631.

Referring to FIG. 6C, the user recording apparatus 620 may encrypt the disc key 631 by using the public key 611 received from the content providing server 610, and may transmit the encrypted disc key 631 to the content providing server 610.

Referring to FIG. 6D, the content providing server 610 may decrypt the disc key 631 encrypted with the public key 611 of the content providing server 610, by using the private key 612 to obtain the disc key 631. Then, the content providing server 610 may encrypt the title key 614, which has been used to encrypt the content 613, by using the disc key 631.

Referring to FIG. 6E, the content providing server 610 may transmit the title key 614 to the user recording apparatus 620. The title key 614 is encrypted with the disc key 631.

Referring to FIG. 6F, the user recording apparatus 620 may record the downloaded CSS encrypted content 613 and the title key 614 on the disc 630. The title key 614 is encrypted with the disc key 631.

Accordingly, the above-described method of FIGS. 6A to 6F may prevent an unauthorized user B from recording the content 613 even when the unauthorized user B intercepts the title key 614.

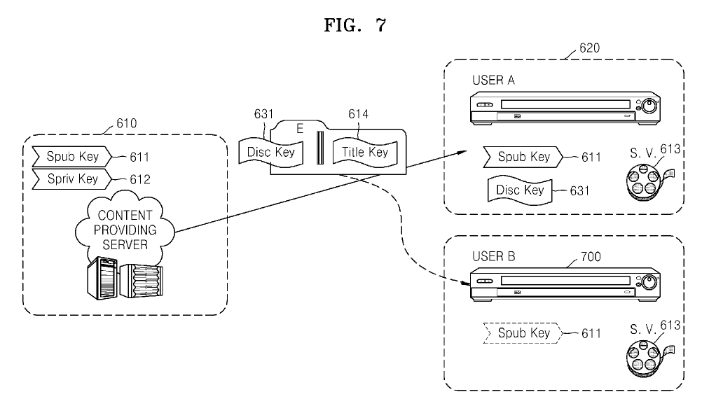

FIG. 7 is a view for explaining advantages of the method of FIGS. 6A to 6F when the unauthorized user B intercepts the title key 614.

Referring to FIG. 7, even if the unauthorized user B intercepts the title key 614, which is encrypted with the disc key 631, during the transmission of the title key 614 from the content providing server 610 to the user recording apparatus 620, the unauthorized user B still may not decrypt the title key 614 because the unauthorized user B would not have the disc key 631 that is used to decrypt the title key 614 which was encrypted with the disc key 631. That is, as a disc key is uniquely assigned to each disc, such that the disc belonging to an authorized user has the authorized disc key 631. Therefore, the unauthorized user B may not decrypt the encrypted title key 614 by using a disc key of a different disc in the possession of the unauthorized user B.

Even if the unauthorized user B intercepts the disc key 631, which is encrypted with the public key 611 of the content providing server 610, during the transmission of the disc key 631 as shown in FIG. 6C in order to obtain the disc key 631 of an authorized user A, the unauthorized user B may not decrypt the disc key 631 that is encrypted with the public key 611 of the content providing server 610. This is because, although the unauthorized user B may decrypt the disc key 631 encrypted with the public key 611 of the content providing server 610, by using the private key 612 of the content providing server 610, the unauthorized user B still would not have the private key 612 of the content providing server 610.

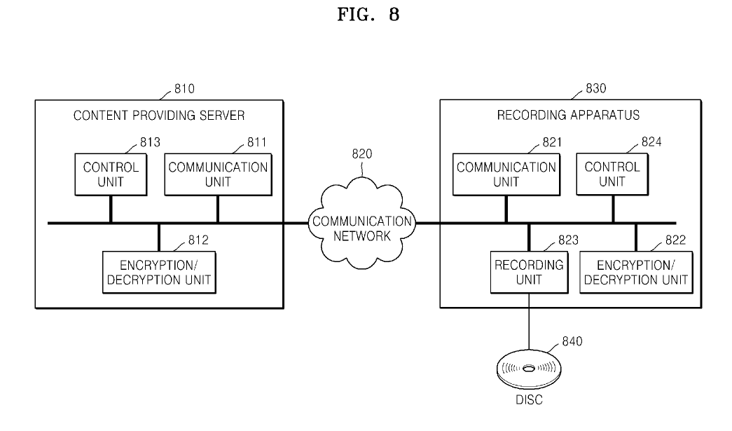

FIG. 8 is a block diagram of a content providing server 810 and a user recording apparatus 830 according to an embodiment.

Referring to FIG. 8, the content providing server 810 may be a computer that provides encrypted content and a title key to the user recording apparatus 830. The title key has been used to encrypt the content. The content providing server 810 may be any type of computer so long as it can provide encrypted content and a title key used to encrypt the content. The content providing server 810 may include, for example, two or more computers so that a computer provides encrypted computer and another computer provides a title key used to encrypt the content.

The user recording apparatus 830 records encrypted content and a title key used to encrypt the content, on a recording disc 840. The user recording apparatus 830 may be any type of recording apparatus so long as it can record encrypted content and a title key used to encrypt the content, on the recording disc 840.

The content providing server 810 and the user recording apparatus 830 may be connected to each other through a communication network 820. That is, the content providing server 810 and the user recording apparatus 830 may transmit and receive other keys that are transmitted and received to securely transmit encrypted content and a title key used to encrypt the content through the communication network 820.

The content providing server 810 may include a communication unit 811, an encryption/decryption unit 812, and a control unit 813.

The communication unit 811 may transmit encrypted content, a title key used to encrypt the content, and other keys to the user recording apparatus 830 through the communication network 820, and may receive predetermined keys sent from the user recording apparatus 830. For example, the communication unit 811 may transmit encrypted content 613, a public key 611 of the content providing server 810, and a title key encrypted with a disc key, to the user recording apparatus 830. The communication unit 811 may receive the disc key, which is encrypted with the public key 611 of the content providing server 810, from the user recording apparatus 830.

The encryption/decryption unit 812 may encrypt or decrypt content and predetermined keys. The encryption/decryption unit 812 may receive the disc key, which is encrypted with the public key 611 of the content providing server 810, from the user recording apparatus 830. The encryption/decryption unit 812 may then decrypt the disc key, which is encrypted with the public key 611 of the content providing server 810, by using a private key of the content providing server 810 to obtain the disc key, and encrypt the title key by using the disc key.

The control unit 813 may control the content providing server 810 to transmit the encrypted content 613 and a title key to the user recording apparatus 830, and may also control the communication unit 811 and the encryption/decryption unit 812.

Although not shown, the content providing server 810 may further include a memory or a hard disc as a storing unit in which the encrypted content 613, the title key, the public key 611, and the private key may be stored.

The user recording apparatus 830 may include a communication unit 821, an encryption/decryption unit 822, a recording unit 823, and a control unit 824.

The communication unit 821 may receive the encrypted content 613, the title key used to encrypt the content 613, and other keys from the user recording apparatus 830 through the communication network 820, and may transmit predetermined keys to the content providing server 810. For example, the communication unit 821 may receive the public key 611, the encrypted content 613, and the title key, which is encrypted with the disc key, from the content providing server 810. The communication unit 821 may transmit the disc key, which is encrypted with the public key 611, to the content providing server 810.

The encryption/decryption unit 822 may encrypt or decrypt predetermined keys. That is, the encryption/decryption unit 822 may read out the encrypted disc key, the encrypted disc key being stored in the recording disc 840, and may decrypt the encrypted disc key by using a player key of the user recording apparatus 830 to obtain the disc key. The encryption/decryption unit 822 may encrypt the obtained disc key by using the public key 611 of the content providing server 810.

The recording unit 823 may record the encrypted content 613 and the title key, which is encrypted with the disc key, received from the content providing server 810 on the recording disc 840.

The control unit 824 may control the recording unit 823 to receive the encrypted content 613 and the title key from the content providing server 810 and to record the encrypted content 613 and the title key on the recording disc 840. The control unit 824 may also control the communication unit 821, the encryption/decryption unit 822, and the recording unit 823. The user recording apparatus 830 may have the player key stored therein.

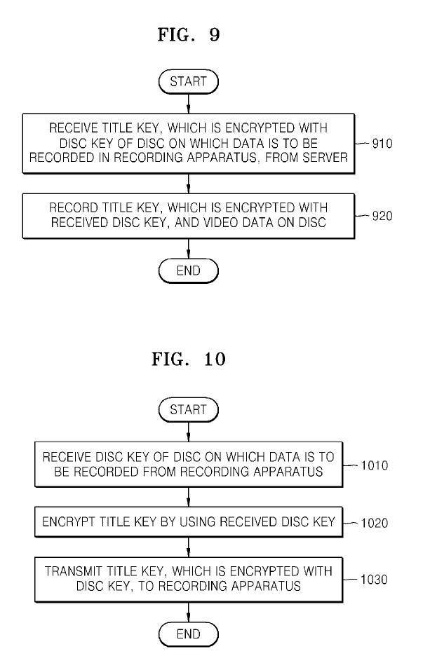

FIG. 9 is a flowchart illustrating a method of recording encrypted content in a user recording apparatus according to an embodiment.

Referring to FIG. 9, in operation 910, the user recording apparatus may receive a title key from a content providing server. Title key is encrypted with a disc key of a disc on which the content is to be recorded. In order to receive the title key that is encrypted with the disc key from the content providing server, the user recording apparatus may transmit the disc key of the disc on which the content is to be recorded to the content providing server. The disc key transmitted to the content providing server may be encrypted by using a public key of the content providing server.

In operation 920, the title key and the content may be recorded on the disc. The title key is encrypted with the received disc key.

FIG. 10 is a flowchart illustrating a method of providing a title key from a content providing server to a user recording apparatus according to an embodiment.

Referring to FIG. 10, in operation 1010, a disc key of a disc on which content is to be recorded may be received from the user recording apparatus. For more stable transmission and reception, the disc key received from the user recording apparatus may be encrypted by using a public key of the content providing server. As such, the content providing server may transmit the public key to the user recording apparatus.

In operation 1020, the title key may be encrypted by using the received disc key. If the received disc key has already been encrypted with the public key of the content providing server, the content providing server may decrypt the disc key, that is encrypted with the public key of the content providing server, by using a private key of the content providing server to obtain the disc key. The content providing server may encrypt the title key, which is used to encrypt the content, by using the obtained disc key.

In operation 1030, the title key may be transmitted to the user recording apparatus. The title key is encrypted with the disc key.

As described above, according to embodiments, unauthorized users cannot record a title key on a plurality of discs.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

As a non-exhaustive illustration only, the computer described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, and devices such as a desktop PC, a high definition television (HDTV), an optical disc player, a setup box, and the like capable of wireless communication or network communication consistent with that disclosed herein.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

Flash memory devices and/or memory controllers may be included in various types of packages. For example, the flash memory devices and/or memory controllers may be embodied using packages such as Package on Packages (PoPs), Ball Grid Arrays (BGAs), Chip Scale Packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Quad Flatpack (QFP), Small Outline Integrated Circuit (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

The flash memory devices and/or the memory controllers may constitute memory cards. In this case, the memory controllers may be constructed to communicate with an external device for example, a host using any one of various types of interface protocols such as a Universal Serial Bus (USB), a Multi Media Card (MMC), a Peripheral Component Interconnect-Express (PCI-E), Serial Advanced Technology Attachment (SATA), Parallel ATA (PATA), Small Computer System Interface (SCSI), Enhanced Small Device Interface (ESDI), and Integrated Drive Electronics (IDE).

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of recording content downloaded from a network, the method comprising:
receiving a title key from a server, the title key being encrypted with a disc key of a disc on which content is to be recorded in a recording apparatus; and
recording the received title key and the content on the disc.

2. The method of claim 1, wherein the receiving of the title key from the server comprises transmitting the disc key to the server.

3. The method of claim 2, wherein the transmitting of the disc key to the server comprises:
receiving a public key of the server from the server;
encrypting the disc key by using the public key of the server; and
transmitting the disc key to the server, the disc key being encrypted with the public key of the server.

4. A method of providing a title key to a recording apparatus for recording content downloaded from a network, the method comprising:
receiving a disc key of a disc on which content is to be recorded from the recording apparatus;
encrypting the title key by using the received disc key; and
transmitting the title key to the recording apparatus, the title key being encrypted with the disc key.

5. The method of claim 4, wherein the receiving of the disc key from the recording apparatus comprises:
transmitting a public key of the server to the recording apparatus; and
receiving the disc key from the recording apparatus, the disc key being encrypted with the public key of the server.

6. The method of claim 4, wherein the encrypting of the title key by using the received disc key comprises:
decrypting the disc key by using a private key of the server to obtain the disc key, the disc key being encrypted with the public key of the server; and
encrypting the title key by using the disc key, the title key having been used to encrypt the content.

7. An apparatus for recording content downloaded from a network, the apparatus comprising:
a recording unit configured to record downloaded content on a disc; and
a control unit configured to:
receive the content and a title key from a content providing server, the title key being encrypted with a disc key of a disc on which content is to be recorded; and
control the recording unit to record the title key and the content on the disc, the title key being encrypted with the received disc key.

8. The apparatus of claim 7, wherein the control unit is further configured to transmit the disc key to the server in order to receive the title key from the server, the title key being encrypted with the disc key.

9. The apparatus of claim 8, further comprising:
an encryption/decryption unit encrypting/decrypting data,
wherein, in order to transmit the disc key to the server, the control unit is further configured to:
control the encryption/decryption unit to encrypt the disc key by using the public key of the server received from the server; and
transmit the disc key to the server, the disc key being encrypted with the public key of the server.

10. A content providing server for providing a title key to a recording apparatus for recording content downloaded from a network, the content providing server comprising:
an encryption/decryption unit configured to encrypt and decrypt data; and
a control unit configured to:
receive a disc key of a disc on which the content is to be recorded from the recording apparatus;
control the encryption/decryption unit to encrypt the title key by using the received disc key; and
transmit the title key and the content to the recording apparatus, the title key being encrypted with the disc key.

11. The content providing server of claim 10, wherein, in order to receive the disc key from the recording apparatus, the control unit is further configured to:
transmit a public key of the server to the recording apparatus; and
receive the disc key from the recording apparatus, the disc key being encrypted with the public key of the server.

12. The content providing server of claim 10, wherein the control unit is further configured to control the encryption/decryption unit to:
decrypt the disc key by using a private key of the server to obtain the disc key, the disc key being encrypted with the public key of the server; and
encrypt the title key by using the disc key, the title key having been used to encrypt the content.
